(19) United States
(12) Patent Application Publication
(10) Pub. No.: US 2026/0312683 A1
(43) Pub. Date: Oct. 8, 2026

(54) LIGHT-BASED DEVICE COMMUNICATION

(71) Applicant: MARKEM-IMAJE CORPORATION, Keene, NH (US)

(72) Inventors: Peter W. GOODENOUGH, Swanzey, NH (US); Cameron Dee DRYDEN, West Roxbury, MA (US)

(21) Appl. No.: 19/484,781

(22) PCT Filed: May 17, 2024
(86) PCT No.: PCT/US2024/030060

§ 371 Date: Nov. 14, 2025

Related U.S. Application Data
(60) Provisional application No. 63/467,139, filed on May 17, 2023.

(51) Int. Cl. H04B 10/116; G06F 3/12

(52) U.S. Cl. CPC H04B 10/116; G06F 3/1293

(57) ABSTRACT

A system including a printer, a light source associated with the printer and configured to emit light at a range of wavelengths, and a controller coupled with the light source. The controller is configured to generate a pulse sequence corresponding to information for the printer and adjust a level of light output by the light source based on the pulse sequence to communicate the information for the printer while making the adjustment of the light output indiscernible to human observation with a naked eye.

### CROSS-REFERENCE TO RELATED APPLICATIONS

This application claims the benefit of priority to U.S. Provisional Application No. 63/467,139, filed on May 17, 2023, entitled “LIGHT-BASED DEVICE COMMUNICATION”, the contents of which are hereby incorporated by reference.

### TECHNICAL FIELD

This specification relates to light-based digital communication.

### BACKGROUND

Production environments can be very busy environments, with many radio-frequency (RF) signals and operating machines being present. Numerous workers can be present in the production environments, e.g., production line supervisors, line operations, and service technicians. The workers may require to connect directly to systems in the production environment, where factory-wide communication networks may not be available or secure.

### SUMMARY

This specification describes technologies for light-based digital communication for a production environment. The technologies include a system for remote monitoring devices in large industrial environments without the need for physical proximity or direct network connection, which is always be available or desirable due to security concerns. In some implementations, the technologies use light-based data transmission to communicate device status information. The device, such as a printer, continuously emits light encoded with information about its status. This light can be captured and decoded by a camera, such as the one on a smartphone, allowing for remote monitoring of the device. These technologies generally involve using a light source of a system, e.g., a printer, deployed in a manufacturing, packaging and/or distribution setting, for device identification and to establish digital communication between the deployed device and a user on a mobile device. In particular, the light source can be used to optically-transmit encoded data using low-flicker, frequency-modulated block-coded pulses. In general, one innovative aspect of the subject matter described in this specification can be embodied in a system including a printer, a light source associated with the printer and configured to emit light at one or more wavelengths, and a controller coupled with the light source. The controller is configured to generate a pulse sequence corresponding to information for the printer, and adjust a level of light output by the light source based on the pulse sequence to communicate the information for the printer while making the adjustment of the light output indiscernible to human observation with a naked eye.

Other embodiments of this aspect include corresponding methods, computer systems, apparatus, and computer programs recorded on one or more computer storage devices, each configured to perform the actions of the methods.

The foregoing and other embodiments can each optionally include one or more of the following features, alone or in combination. In particular, one embodiment includes all the following features in combination.

In some implementations, the one or more wavelengths include at least a wavelength of infrared light, e.g., 940 nanometer light.

In some implementations, the one or more wavelengths include a wavelength of visible light and a wavelength of infrared light.

In some implementations, the controller is configured to adjust the level of the light output by the light source in accordance with predefined indicator codes, where a timing of spaces between the indicator codes, during which the level of the light output is not adjusted, indicates the information being communicated. The information can include a wired or wireless network address for the printer.

In some implementations, the controller is communicatively coupled with the printer, and the controller is configured to receive, from the printer, data for the printer, and encode the data for the printer in the timing of the spaces between the predefined indicator codes to generate the pulse sequence. The controller can be configured to make the adjustment of the light output indiscernible to human observation with a naked eye at least in part by adjusting the level of the light output at a frequency above 75 Hertz.

In some implementations, the light source is (i) a tower light, (ii) a light emitting diode, or (iii) a laser source.

In some implementations, the light source includes the light emitting diode coupled with focusing optics to produce a narrow beam illumination source.

In some implementations, the light source is a first light source, where the system further includes a second light source including a different emission wavelength from the first light source. The controller can be coupled with the second light source and configured to generate a second pulse sequence corresponding to second information for the printer and adjust a level of light output by the second light source to communicate the second information for the printer while making the adjustment of the light output indiscernible to human observation with the naked eye.

In some implementations, the information further includes one or more of (A) a printer status update, (B) a fault/error code, (C) connectivity, and (D) the printer or software configuration.

In some implementations, adjusting the level of light output by the light source includes adjusting an intensity of the light output of the light source between 0 to 100%. The pulse sequence can include adjusting the light output of the light source to a steady-state of 50% intensity of a total light output for the light source for a period of time. A period of a light pulse of the pulse sequence can be selected based on a frame rate of a receiving camera of a mobile device.

In some implementations, generating the pulse sequence includes encoding the information using an optical encoding scheme including valid states of 0%, 50% and 100% intensity of the light source, where a steady-state of the light source includes a 50% intensity of the light source. The optical encoding scheme can include (i) a defined state and end of pulse sequences and (ii) a defined character map(s). Generating the pulse sequence can include determining a number of frames for the pulse sequence corresponding to the information, and in response to determining the number of frames is a multiple of 50 Hz or 60 Hz, inserting an additional frame into the pulse sequence to reduce a sensitivity to the 50 Hz or 60 Hz ambient light flashing. The optical encoding scheme can include alpha-numerical characters as the steady-state of the light source, where a value of the alpha-numerical characters is encoded as steady-state light signal for a set number of frames of a receiving camera of a mobile device. The optical encoding scheme can include a set of indicator codes, each of the indicator codes including a predetermined number of sequential light pulses, where the set of indicator codes includes: (A) a start code corresponding to a predefined code, (B) a start code corresponding to a user-defined code, (C) a new character code, (C) a stop code. In some implementations, the set of indicator codes further includes a validation code, where the validation code includes a checksum start code.

In general, another innovative aspect of the subject matter described in this specification can be embodied in a system including a printer, a light source associated with the printer and configured to emit light in a human visible spectrum, and a controller coupled with the light source. The controller is configured to generate a pulse sequence corresponding to information for the printer, and adjust a level of light output by the light source based on the pulse sequence, in the human visible spectrum, to communicate the information for the printer while making the adjustment of the light output indiscernible to human observation with a naked eye.

In general, another innovative aspect of the subject matter described in this specification can be embodied in one or more non-transitory computer storage media encoded with computer program instructions that, when executed by one or more computers cause the one or more computers to perform operations including initiating a decoding application in an application environment on a user device, the decoding application accessing a camera of the user device. The operations include presenting, in a display of the user device and in the application environment, a view of the camera of the user device, where the view of the camera includes a reference window guiding a user to capture a light signal from a light source of interest. The operations include capturing, using the camera, multiple video frames including the light signal from the light source, and identifying, by the decoding application and within the captured video frames, a pulse sequence in the light signal emitted by the light source, the pulse sequence encoding information.

In general, another innovative aspect of the subject matter described in this specification can be embodied in a method including generating, by a controller coupled to a light source associated with a printer, a pulse sequence corresponding to information for the printer, where the light source is configured to emit light in a human visible spectrum. The method includes adjusting, by the controller, a level of light output by the light source based on the pulse sequence, in the human visible spectrum, to communicate the information for the printer while making the adjustment of the light output indiscernible to human observation with a naked eye.

In some implementations, the method further includes initiating a decoding application in an application environment on a user device, the decoding application accessing a camera of the user device. The method further includes presenting, in a display of the user device and in the application environment, a view of the camera of the user device, where the view of the camera includes a reference window guiding a user to capture a light signal from the light source, the light signal including the pulse sequence corresponding to the information for the printer. The method further includes capturing, using the camera, video frames including the light signal from the light source, and identifying, by the decoding application and within the captured video frames, the pulse sequence in the light signal emitted by the light source, the pulse sequence encoding the information for the printer.

The subject matter described in this specification can be implemented in various embodiments so as to realize one or more of the following advantages.

In industrial environments, such as mass production floors, monitoring the status of various devices and equipment is critical. However, these environments can be vast, requiring supervisors or engineers to physically traverse the area to check the status of each device, which can be time-consuming and inefficient. Each light source corresponding to a deployed device (e.g., a signal tower or light emitting diodes of an industrial printer) in a manufacturing setting can be repurposed to broadcast a (at least locally) unique identifier encoded in the light pulses such that a camera of a mobile device (e.g., mobile phone camera) can capture and decode the information.

By encoding data into light emissions, the technologies can allow for real-time communication and device monitoring without requiring physical proximity or direct network connection, increasing efficiency in large production environments, by reducing the need for supervisors or engineers to physically traverse the area to check the status of each device.

The encoded data can include a wide range of information, such as device faults and warnings, batch numbers, number of items printed, remaining print jobs, and specifics of the last print job, among other things. The data can provide a detailed picture of the device operations and status, for example, allowing for proactive maintenance and issue resolution. In some implementations, the decoded information can be used by the mobile device to flexibly establish reliable peer-to-peer communications with individual systems directly, without having to invest in a factory-wide Wi-Fi network or Bluetooth mesh network. The light pulses can be selected to be observable by a camera of a mobile device but imperceptible to a user. A secured look up table (LUT) can be used to store specific deployed device internet protocol (IP) and/or Bluetooth addresses such that only a user having access to the secured LUT can use the digital communication from a deployed device to connect to the device. The subject matter described in this specification can be implemented to facilitate identifying a network or Bluetooth address of a specific system in a production environment without a user having to be sufficiently physically close to the system to read text or bar code symbology present on the system. In some implementations, the network protocol supports the use of user-defined symbology and can include dynamically-changing data such as machine-specific alerts, machine identification, and other information, and the use of non-Latin character sets to convey characters of any language. In some implementations, the subject matter described in this specification can also incorporate signal light color(s) for more efficient information transmittal. Moreover, the systems and techniques described in this specification need not be limited to printers in a production environment, and can be applied in various other contexts that can benefit from device signaling, e.g., where an industrial device can identify itself and send various types of information, such as the device's current status and/or the device's network address, e.g., a modified Internet Protocol (IP) address.

In some implementations, the use of light for data transmission can provide enhanced data security, as the data can be easily encrypted and can be less susceptible to interception than traditional wireless communications.

Furthermore, the technologies can be designed to adapt to different global standards and protocols for light-based communication. This includes the ability to automatically adjust the light pulses based on regional regulations, ensuring compliance and interoperability across different regions. This can be particularly beneficial for multinational corporations that operate in several countries with different regulatory standards.

The data encoded into the light can include various types of information, such as device faults and warnings, batch numbers, number of items printed, remaining print jobs, specifics of the last print job and the like. The encoding of the data into the light can be done using a specific protocol developed for this purpose. This protocol allows for a large amount of data to be encoded into the light emissions, providing detailed status information.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example of an operating environment of a light-based digital communication system in a production environment.

FIG. 2 shows another example of an operating environment of a light-based digital communication system in a production environment.

FIG. 3 depicts a schematic plot of a light output trace used to define a percent flicker and flicker index.

FIG. 4 depicts an example of a tri-state optical encoding scheme.

FIG. 5 depicts an example of encoded information using an optical encoding scheme.

FIGS. 6-10 depict examples of encoding schemes for a set of code identifiers.

FIGS. 11-14 depict examples of optically-encoded pulse sequences using an optical encoding scheme.

FIGS. 15A-C depict examples of optically-encoded pulse sequences using an optical encoding scheme.

FIG. 16 depicts a schematic of an example of a controller for operating a light source of a printer.

FIG. 17 is a flowchart of an example of a process for encoding digital communication and transmitting the encoded optical signal with a light source.

FIG. 18 is a flowchart of an example of a process for decoding digital communication from a light source.

FIG. 19 is a block diagram of an example of a computer system.

FIG. 20 depicts an example of using focusing optics to produce a narrow, non-omnidirectional beam of light.

FIG. 21 shows a production environment including two or more production systems with respective light sources within range of a single location from which a camera of a mobile device can detect signals from the respective light sources.

Like reference numbers and designations in the various drawings indicate like elements.

### DETAILED DESCRIPTION

In the rapidly evolving landscape of Industry 4.0, the need for real-time monitoring and control of industrial equipment has become increasingly critical. This can be particularly true in vast industrial environments where efficient management of numerous devices can be required to ensure smooth operations. Traditional methods of monitoring, such as manual inspections or network-based monitoring, can often fall short in such settings due to inherent limitations of those approaches. For example, manual inspections can be labor-intensive and time-consuming, while network-based monitoring can be hindered by security risks and the unavailability of comprehensive network coverage in large industrial sites.

This specification describes technologies for light-based digital communication for a production environment, e.g., for remote device monitoring in industrial environments.

While the specification describes the technologies as applicable in industrial environments, the technologies can be applicable to wide-ranging applications in scenarios where remote monitoring of a device is beneficial. For example, the technologies can be used to monitor the status of heating, ventilation, and air conditioning (HVAC) systems, automobile maintenance intervals, or other devices that emit light.

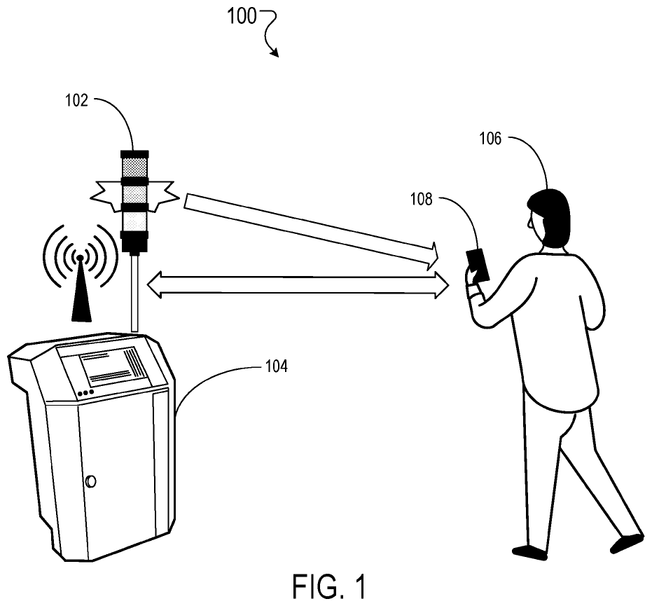

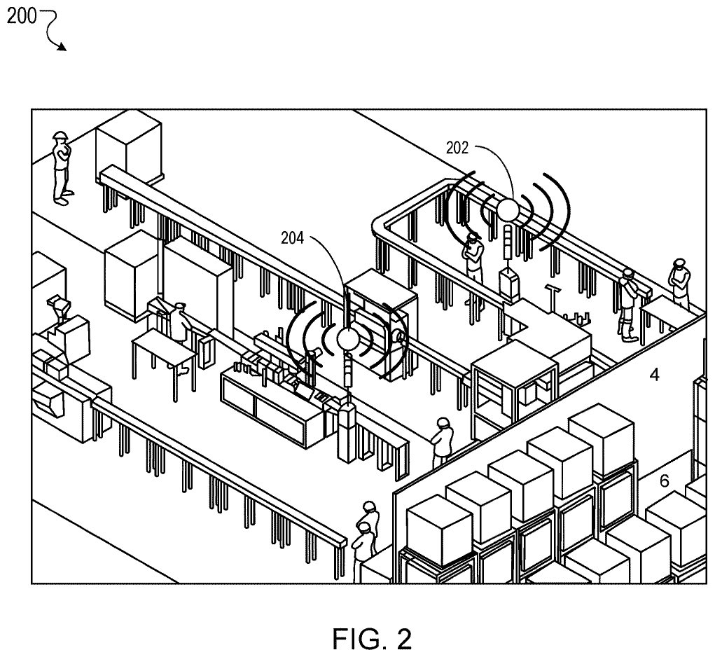

FIGS. 1 and 2 show example operating environments of a light-based digital communication system in a production environment. A production environment can be, for example, a manufacturing facility including production systems deployed in the manufacturing facility, e.g., a fast-moving consumer goods packaging plant. A production environment can include multiple different types of production systems configured to perform various functions, e.g., fabrication/manufacturing, sorting, packing, labeling, printing, etc. A production environment can include multiple types of production systems which can include respective signal towers and/or programmable light emitting diodes (LEDs) for conveying, for example, system status/alerts. For example, production systems can include one or more of a conveyor, bagger, weigh scale, filler(s), taper, carton erector, or the like. A production environment can include one or more industrial printers, e.g., for printing labels on parts and/or on packing. In some implementations, the production environment can include multiple packaging systems (e.g., multiple packing lines) each with a designated printer for marking and coding. The production environment can be an electro-magnetically noisy environment, e.g., in the RF spectrum. In some implementations, a production environment can include multiple types of human operators, e.g., line supervisors, line operators, and/or service technicians, where the human operators may need to connect to and/or acquire information from a production system in real-time with or without being immediately adjacent to the production system. Moreover, space may be limited in a way that makes it difficult for a person to get close to the production system without also getting close to operating machinery, which can cause risk of injury.

In some implementations, the light-based digital communication can be further extended to include a variety of other functionalities. In some examples, the light source can be utilized to transmit updated instructions or modifications to the operation of the production system. Transmission of updated instructions or modification of the production system can be useful, e.g., in situations where immediate changes to the system operation are required. The encoded data can be tailored to instruct the production system to alter its operations, for instance, changing the speed of a conveyor belt, altering the printing pattern, or modifying the filling quantity in a packaging system. Real-time, light-based communication can facilitate immediate changes to the system operations, thereby enhancing the efficiency and adaptability of the production environment.

As depicted in FIG. 1, operating environment 100 including a light source 102, e.g., a signal tower light (or other light), attached to a production system 104, e.g., an industrial printer, can be used for address identification and digital communications. In some implementations, some printers (e.g., laser and print & apply printers) have an associated signal tower light for safety reasons, where the light is generally required to be within two meters of where the actual printing takes place. The tower light can be located such that it is visible from a distance, e.g., mounted high and within line of sight of operators and supervisors. For example, as depicted in FIG. 2, a production environment 200 including multiple production systems can each have respective tower lights, e.g., tower lights 202, 204, where each tower light can communicate via the light-based signal communication described in this specification.

In some implementations, printers lack a tower light, such that a status light on the printhead or controller itself, e.g., light emitting diodes (LEDs), are used to perform the same function. In some implementations, a light source can be located in proximity of the production system and be in data communication with the production system and be used for address identification and digital communications. The light source can be positioned with respect to the production system to provide line of sight data communication to a user nearby the production system, e.g., mounted on a wall, ceiling, or overhead, such that the light source is accessible by a camera of a user's mobile device.

A light source used for address identification and digital communications includes emission wavelength ranges that overlap with detection wavelength ranges of images sensors of smart devices, e.g., embedded cameras of smart phones, tablets, or other handheld smart devices. For example, as depicted in FIG. 1, a user 106 can use a camera of a mobile phone 108 to receive light-encoded signal from the light source 102. The emission wavelength range of the light source can be, for example, in the infrared wavelength range, visible wavelength range, or a combination of both. In some examples, a light source can be an LED emitting in the blue, red, yellow, green, orange, or other visible wavelength range. In some examples, a light source can be an infrared LED or laser emitting in the near infrared wavelength range, e.g., about 940 nanometers (nm). In some examples, a light source can be an ultraviolet (UV) LED or laser emitting in the UV wavelength range.

In some implementations, a controller of the system (e.g., of an industrial printer) can be used to control operations of the light source to transmit data using the light source coupled to the system. In some implementations, a component can be added/retrofitted to existing systems (or other components with light sources) including a controller for controlling operations of the light source to transmit data using the light source.

In some implementations, a digitally-encoded, “low-flicker”, frequency-modulated, block-coded pulse can be used to optically encode and transmit the data using a light source coupled to the system, e.g., signal tower lights. As used herein, the flicker of a light pulse is “low” when the encoded pulse frequency is set sufficiently fast as to be invisible (or indiscernible/imperceptible) to a human observer. In one example, indiscernible to a human user includes a repetitive wave (e.g., square wave) with a repetition >75 Hertz (Hz). In another example, indiscernible to a human user includes an effective frequency of the encoded signal during transmission that is >75 Hz, i.e., for an encoded signal of “1001” transmitted at frequency of 150 Hz such that the effective frequency of transmitting the “00” values is 150 Hz/2=75 Hz. A frequency of the block-coded pulse can be set sufficiently slow to be visible (or discernible) to common mobile device cameras, e.g., smart phone cameras. For example, mobile device cameras can have 240 frames/second video capture capability corresponding to a 4.166 millisecond (ms) pulse that can be captured by the camera. In another example, mobile device cameras can have 480 frames/second video capture capability corresponding to a 2.083 ms pulse or 960 frames/second video capture capability corresponding to a 1.042 ms pulse.

In some implementations, an encoding scheme for encoding information and transmitting using the light source can be selected to be sufficiently imperceptible to a human viewer, e.g., subconsciously and consciously. In some implementations, light source controllers, e.g., LED drivers, can be used to operate the light source to generate robust optical signal transmission.

The encoded pulse information can be recovered using a decoding application on a user's mobile device, e.g., a smart phone. The decoding application can capture the pulsed light signal through a camera of the mobile device and the application can decode the information, e.g., using a look-up table (LUT) mapping a pulse light signal train to alpha-numerical values, e.g., hexadecimal values. Transmittable information can include, for example, an actual IP, Bluetooth, or other wireless network address identifying the system (e.g., a printer), decoded (LUT) system identifiers, presence of system fault and/or warning/alerts, detailed system faults and/or warnings, other system alerts related to status (e.g., ready/printing/off/not ready status), time & date, system model & configuration, software version, service/maintenance information, batch count or another production status update, or the like.

In some implementations, the encoded pulse information can be decoded and mapped (e.g., using a LUT) to distinguish a limited set of IP or Bluetooth addresses representative of the deployed systems in the production environment. Once the decoding application on the mobile device decodes the IP or Bluetooth address, the decoding application can establish a high-speed data connection using the RF transmission of the system.

In some implementations, a deployed system Wi-Fi or Bluetooth antenna can be co-located with the light source (e.g., co-located with the tower light or in its stalk), making use of its location and field of view in the production environment to maximize RF transmission distance. For example, for Bluetooth Class 2-enabled mobile devices, a transmission distance can range up to about 10 meters, with decreasing range based in part on a degree of electrical noise in the production environment. In another example, in a Wi-Fi-enabled production environment including Wi-Fi signal repeaters, full coverage anywhere in the factory can be achievable, although the individual range to a single repeater can be less than a full range of the production environment. Wi-Fi operating at 2.4 GHz can have a transmission distance range of up to about 45 meters. Wi-Fi operating at 5 GHz can have a transmission distance of up to about 15 meters. In some implementations, optical communications can extend a transmission distance range from about 15 feet to about 50 feet-75 feet by modifying the modular signal tower lights. In another example, in implementations where QR codes on the printer are used to establish communication links to mobile device(s), the transmission distance range can be up to about 0.5 meters away.

In some implementations, a network address for a deployed system can be encoded in light pulse signals where a network address can be a Wi-Fi address including either an IPv4 or IPv6 address. In the case of an IPv4 address, a maximum length of an address is 15 characters [(8 bits×4)+ (3×8 ASCII bits)=56 bits]. Integers “0-9” and “.” can be part of an IP address. Integers “0-9”, “.”, and “-” can be part of an IP address range. The range of IP addresses can be between 0.0.0.0 and 255.255.255.255, where the range is included in Class A, Class B, or Class C. In the case of an IPv6 address, the address can be written as eight groups of four hexadecimal digits, where each group is separated by a colon (:) (e.g., FFFF: FFFF: FFFF: FFFF: FFFF: FFFF: FFFF: FFFF, which is (16 bits×8)+ (7×8 ASCII bits)=184 bits, max.). Any leading zeros in a group can be omitted. One or any number of consecutive groups of 0 values can be replaced with two colons (::). This substitution with a double-colon can be performed only once in an address, e.g., because multiple occurrences can lead to ambiguity. Generally, a network can be denoted by the first address in the network and the size in bits of the prefix, separated by a slash “/”.

In some implementations, a network address for a deployed system can be encoded as light pulse signals where a network address can be a Bluetooth address. A Bluetooth address includes a 48-bit value (e.g., 12 hexadecimal digits) that uniquely identifies a Bluetooth-enabled device.

### Light-Based Digital Communication

Light-based digital communication can include encoding information into a sequence of light pulses, where characteristics of the light pulses, for example, timing, frequency, amplitude/intensity, pattern, color, etc., can be used to encode and transmit the data. In some implementations, characteristics of the light pulses can be selected to be substantially undetectable by a human observer while also being detectable by a camera having at least a threshold number of frames/second capability, e.g., 240 frames/second. Additionally, characteristics of the light pulses can be selected to avoid triggering a human viewer who is photosensitive, e.g., have epilepsy or another photosensitive condition. For example, a frequency range between 5-30 Hz can be avoided due to an increased likelihood of triggering a photosensitive response. In another example, an intensity (e.g., brightness and/or contrast between light/dark) during a pulse or flicker of a light source can be selected to be less than about 20 candelas per square meter. In another example, an area that a light stimulus occupies of a human viewer's visual field can be selected to be less than about 25 percent of a total area of the field of view of the human viewer. In another example, a pattern or color(s) in an image generated by the light source including light and dark regions can be selected to be less than a threshold pattern of light/dark or colors to avoid triggering a photosensitive reaction. In another example, a wavelength of the light of the light pulses can be selected to be outside a normal viewing range of wavelengths of a human eye, e.g., outside the 400-700 nm spectrum. The wavelength of light not visible to the human eye can be detectable by image sensors configured to detect wavelengths of light in the infrared or ultraviolet spectra.

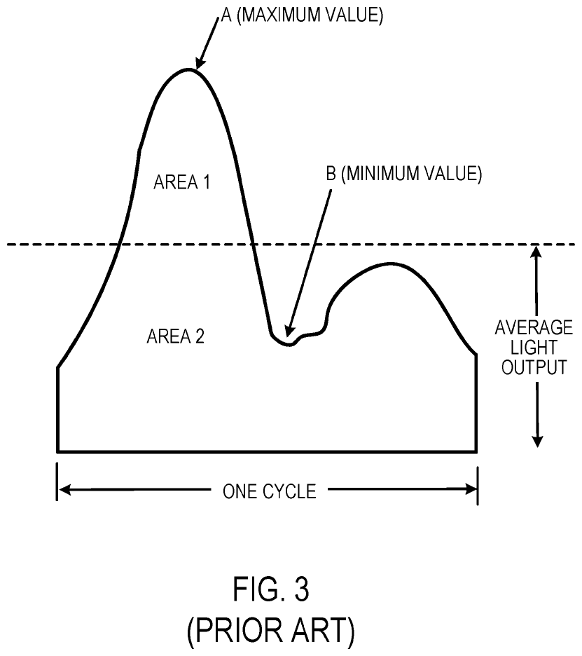

Light pulses of a light source, as used in this specification, can be defined in part based on a flicker of the light source, e.g., a percent flicker and/or a flicker index. Percent flicker (also known as a “modulation index”) of the light source is a relative measure of the cyclic variation in output of a light source (e.g., percent modulation). Referring now to FIG. 3, the percent flicker is represented as:

$$Percent flicker = 100 \times \frac{( A - B )}{( A + B )} \qquad ( 1 )$$

where A is the maximum value and B is the minimum value of the output of the light source.

A flicker index is a relative measure of the cyclic variation in output of various sources at a given power frequency which takes into account a waveform of the light output as well as its amplitude. The flicker index ranges in value from 0 to 1.0, where 0 is a steady light output and increasing values indicate an increased probability of discernable light source flicker by a human observer, as well as a stroboscopic effect.

$$Flicker index = \frac{Area 1}{Area 1 + Area 2} \qquad ( 2 )$$

where Area 1 is the area under the curve between the average light output and the maximum value of the curve, and Area 2 is the area under the curve between the average light output and an “off” light value, e.g., zero.

### Optical Encoding Schemes

An optical encoding scheme can be used to encode information into a pulse sequence transmittable by a light source (e.g., or light sources) such that a decoding application operating on a user's mobile device can process the pulse sequence in captured frames by the camera of the user's mobile device and decode the pulse sequence into the information. In some implementations, an optical encoding scheme can be based in part on a camera frame rate of a receiving camera, e.g., a camera of a smart phone. As described in the examples below, an optical encoding scheme is based on a camera frame rate of 240 frames/second (fps) corresponding to a “slow-motion video” capture rate of many cameras in mobile devices. Other frame rates are possible, e.g., 480 fps or 960 fps. According to some optical encoding schemes, time is divided into 4.166 millisecond units, corresponding to a single frame of a camera having a 240 fps capture rate.

A system that encodes information via the flashing of visible light can include the following characteristics: (A) low flashing perceptibility, (B) low lighting flicker, (C) fast system ID (identifier) decode speed (first time), (D) fast system ID decode speed/short error recovery time (after the first time), (E) high system ID decode ambient noise rejection, and (F) high system ID decode distance (e.g., a distance from user with mobile device to a transmitting light source).

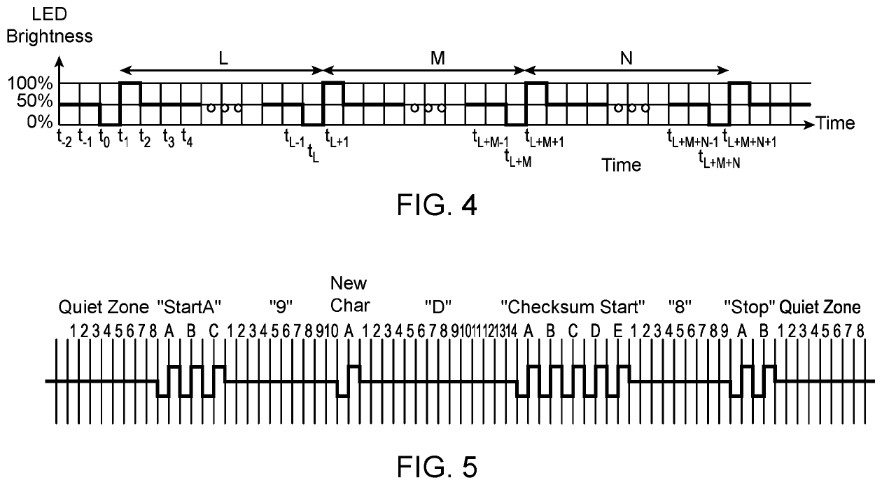

As depicted in FIG. 4, an encoding scheme includes a tri-state optical encoding scheme, with valid states of 0%, 50% and 100% brightness of the light source, where a nominal state of the light source (e.g., LED) is at a 50% brightness. As depicted, a 0% (off) pulse with an immediately-following 100% pulse yields a combined average intensity of 50% that matches the steady-state LED brightness, making the pulse pairs imperceptible by most people under most conditions. In other words, an average 0-100% pulse-pair intensity is the same as the background (50%), so the eye doesn't perceive the pulse pairs discreetly embedded within a pulse waveform. As depicted in FIG. 4, information transmitted is represented as “L”, “M”, and “N”, corresponding to the spacings between each pair of adjacent pulses, respectively.

In some implementations, an optical encoding scheme to transmit information includes one or more of (i) a defined state and end of pulse sequences, (ii) a defined character map(s), and (iii) a reduced sensitivity to 60 or 50 Hz ambient light flashing. The optical encoding scheme can include one or more of (A) alternating patterns of light and dark, (B) data transmission interpreted from left to right (i.e., from time=t0 to time >t0), and (C) data encoding that benefits an ease of decoding, flexibility of meaning, error detection, and/or error correction.

In some implementations, an encoding scheme can be modeled on code 128 bar code standards and structure, while maintaining imperceptible flicker to a human user and insensitivity to ambient optical false signaling (e.g., due to ambient lights having 50 or 60 Hz flickering). For example, the optical encoding scheme can include “quiet zones” present before and after the encoded data signal. In another example, the optical encoding scheme can include a specific “Stop” code (value of 106 for Code 128). In another example, the optical encoding scheme can include specific “Start” codes, each signifying different meanings for the data following.

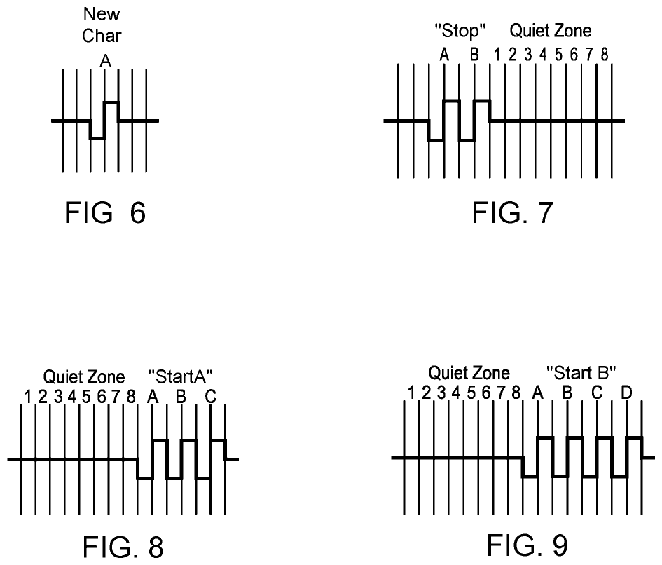

FIG. 5 depicts an example of encoded information using an optical encoding scheme. The optical encoding scheme includes a set of indicator codes:
1 pulse pair—Character Delimiter
2 pulse pairs—Stop (end of data transmission)
3 pulse pairs—Start Data transmission, Encoding Scheme A (hexadecimal digits only; 16 unique values)
4 pulse pairs—Start Data transmission, Encoding Scheme B (user-defined)
5 pulse pairs—Start Checksum Character(s)

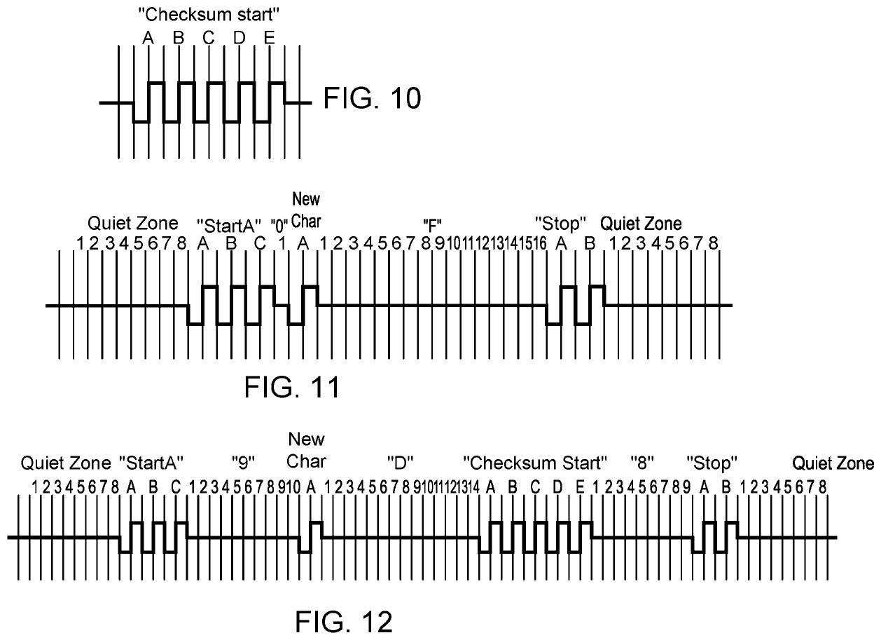

FIGS. 6-10 depict example encoding schemes for a set of code identifiers. FIG. 6 depicts a character/code indicator code pulse signal, e.g., a “new character” indicator in a pulse sequence. As depicted, the character indicator code is encoded as a single 0-100% pulse pair. After a data sequence has been initiated using a “start A” or “start B” code, an appearance of a “new character” indicator code, preceded by at least one camera frame at 50% brightness, can be used to indicate (i) a start of a new character (e.g., start A) or (ii) a start of a new user-defined code (e.g., start B).

FIG. 7 depicts an indicator code for an end pulse signal of pulse sequence transmission, e.g., a “stop code.” The “Stop” code consists of two 0-100% brightness pulse pairs in succession, where the “Stop” code signifies that the data sequence being transmitted is now ended. The stop code can be preceded by at least one frame at 50% brightness and followed by a “Quiet Zone” of a set of frames at 50% brightness, e.g., at least about 8 frames. In some implementations, if the data sequence was started by a “Start A” code, “Stop” ends the predefined data code sequence. In some implementations, if the data sequence was started by a “Start B” code, “Stop” ends the user-defined data code sequence. In some implementations, if the data included a “Checksum Start” code, “Stop” indicates that no more checksum digits will follow.

FIG. 8 depicts an indicator code for a start of a data sequence based on predefined codes, e.g., a “start A” code. The “Start A” code can include of three 0-100% brightness pulse pairs in succession. “Start A” indicates the start of a predefined data sequence with either numeric hexadecimal digits and/or upper-case Latin characters A-Z. Numeric values can be transmitted as hexadecimal (base 16) for efficiency. According so some encoding schemes, “start A” can be preceded by a Quiet Zone of a set of camera frames, e.g., at least about 8 frames.

In some implementations, steady-state light signal frames following a “start A” code for a set number of one or more frames can be assigned to a unique alpha-numerical value. Two or more sets of one or more frames can be separated by a “new character code” following the “start A” code, each set corresponding to a unique alpha-numerical value. The set number of frames corresponding to each of the alpha-numerical characters can be defined, for example, in a LUT for the encoding scheme. The LUT can include an “N” value corresponding to a number of video frames per code, and an alpha-numeric value is assigned to each N value. Additionally, an N value can be assigned to user-defined codes. In some implementations, numbers can be assigned to the shorted codes, e.g., the values of N=1-10. Numerical values can be interpreted as base-16 (hexadecimal, 0-9, and A-F). For example, using hexadecimal values, IPv4 addresses can be sent as four pairs of two hexadecimal digits. The LUT can include, for example, Latin uppercase characters, e.g., A-Z, as well as special characters, each represented as a unique number of frames N. In the example depicted in FIG. 5, alpha-numerical characters “9,” “D,” and “8” are included in the example pulse sequence as non-pulses, e.g., as steady-state light signal for a set number of frames.

In some implementations, an optical encoding scheme includes a limit to a length of the alpha-numeric character by limiting a length of “N,” e.g., the number of video frames (4.166 milliseconds each) that is allowed for the alpha-numerical characters. Limiting a number of frames that can represent a given alpha-numeric character can limit a time required to transmit and decode a single character as well as limit a transmitting light source and receiving camera pulse width (e.g., clock) precision requirements to +/−1%. For example, a value of N can range between 1 and 100 frames.

FIG. 9 depicts an indicator code for a start of a data sequence based on user-defined codes, e.g., a “start B” code. The “Start B” code can include four 0-100% brightness pulse pairs in succession. “Start B” indicates the start of a user-defined data sequence. In this case, the meaning of each data code that follows (N frames at 50% brightness followed by a Character/Code Delimiter, Checksum Start, or Stop code, where 1≤N≤100), is defined by the user. User-defined characters or codes can have any meaning intended by the user. A number of unique user-defined codes can depend, in part, on a number of frames (e.g., a time interval) to transmit each code. For example, a limit on a time interval to transmit a code can dictate an upper bound on an N number of frames (and therefore an N number of unique codes) that can be defined by the user. To be meaningful, those meanings must be both defined at the signal transmitter and the receiving cell phone application. For example, some possible user-define code meanings can include, (i) non-Latin characters or symbols (e.g., Kanji strokes, Greek letters, punctuation, etc.), (ii) system fault/warning codes (e.g., “Low on Ink; Conveyor stopped; etc.), or (iii) mapped system IP addresses (e.g., Printer “1” maps to XXX.XXX.XXX.XXX; Printer “2” maps to YYY.YYY.YYY.YYY, etc.). According so some encoding schemes, “start B” can be preceded by a Quiet Zone of a set of camera frames, e.g., at least about 8 frames.

In some implementations, a steady-state light signal for a set number of frames can be assigned to a unique pre-defined message, where a set of pre-defined messages are each assigned a different number of non-pulse frames in a LUT for the encoding scheme. For example, an encoding scheme can include definitions of different 3-digit number codes, each representing a piece of machine status. In another example, an encoding scheme can include 4-, or 5-digit numerical codes. In another example, an encoding scheme can include pairs of numbers, where the first number specifies a type of machine information (e.g., machine model or “warning”), and a second number details the relevant information. In another example, the encoding scheme can include three-number codes. In some implementations, a “start B” LUT can be used to store user defined codes, where an encoded value N can be any character represented within a set of scripts. For example, a “start B” LUT can include a character within scripts defined by the Unicode 15.0 standard, where the user can assign codes to characters of included in one or more scripts. In some implementations, a user can generate an encoded message using a mix of different scripts and different types of characters (e.g., numbers, letters, symbols, special characters) within an encoded “start B” message.

In some implementations, a “start B” encoded sequence can precede a “start A” encoded sequence, where the “start B” encoded sequence provides information, context, or definition of the start A message. For example, a start B encoded sequence can transmit an identifier “Printer IPv4 Address” as one or more N values defined in a start B LUT, where a start A encoded sequence following can include the IPv4 hexadecimal address (e.g., FFE7FFD0). In another example, a start B encoded sequence can transmit an identifier “Printer Fault Code” as one or more N values defined in a start B LUT, where a start A encoded sequence following can include the fault code value, e.g., “B7.” In another example, a start B encoded sequence can transmit an identifier “Warning” as one or more N values defined in a start B LUT (and which can be a non-English language), where a start A encoded sequence following can include the fault warning value (e.g., “C3”). Thus, allowing the “start B” message to precede the “start A” sequence to define it meaning enables extensive message flexibility.

In some implementations, an encoding scheme can include both start A and start B codes. For example, N values of 1-59 can be assigned to numbers, letters, and special characters, and N values of 60-100 can be user-defined.

FIG. 10 depicts an indicator code for a validation code, e.g., a “checksum start” code. A “Checksum Start” can include five 0-100% brightness pulse pairs in succession. It indicates the start of the transmission of one or more hexadecimal (base 16) checksum digits which can be used to validate an accuracy of the transmission received by a receiving decoding application. The checksum digit sequence can end with a “Stop” code, as described above. In cases that multiple checksum digits are transmitted, digits can be separated by a “Character/Code Delimiter” code, as described above. The checksum start code can be followed by a set of frames which are added together (e.g., the checksum) by both the transmitter and the receiver, where the values of the checksum calculated by the transmitter and the receiver are validated against each other. For example, a receiving decoding application can receive and sum the set of frames following the “checksum start” code until receiving either a “stop” code or a “new character” code to compute a checksum value. The decoding application can then receive and decode a checksum value computed by the transmitter (e.g., the controller operating the light source transmitting the data sequence) and compare the received checksum value from the transmitter to the checksum value computed by the decoding application.

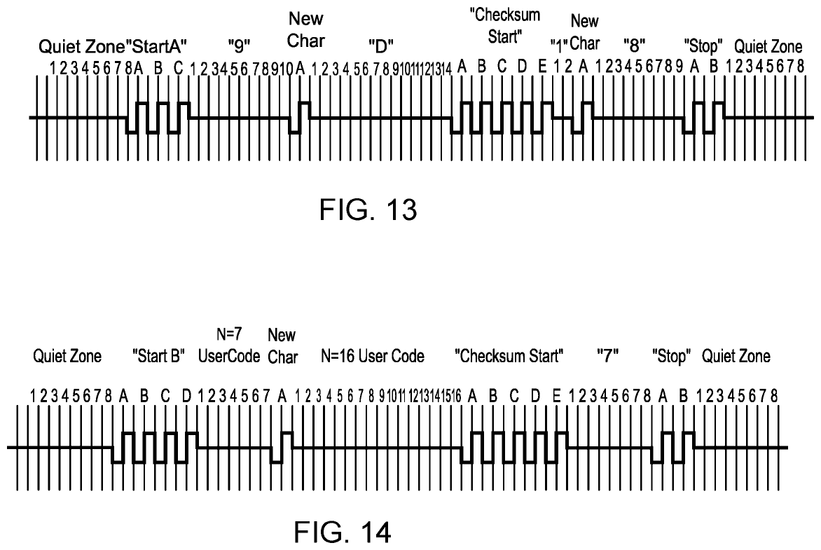

FIGS. 11-14 depict examples of optically-encoded pulse sequences using an optical encoding scheme. FIG. 11 depicts an example pulse sequence including a data sequence of predefined, numeric characters. The data sequence of FIG. 11 does not include a checksum digit sequence. As depicted in FIG. 11, the data sequence includes a Quiet zone of at least 8 frames at 50% brightness, followed by three 0-100% pulse pairs in succession to identify the “Start A” code, signifying our predefined codes will follow. A single frame at 50% signifies the hexadecimal digit “0”. A single 0-100% pulse pair signifies a New Character will follow. 16 frames at 50% signify the predefined hexadecimal digit “F”. Two 0-100% pulse pairs signify data sequence “Stop”. Finally, another Quiet Zone coded signal of at least 8 frames at 50% brightness follows after the Stop code affirms the end of the data sequence. The depicted sequence of FIG. 11 can have an advantage of relatively quick transfer (e.g., transmission). For example, a relatively quick transfer can be between about 1.2 to about 1.5× faster for a data sequence not including a checksum compared to a data sequence including a two-digit checksum value. In some implementations, for example, in a low-optical-noise environment (e.g., the cell phone is very close to the blinking light), the approach depicted in FIG. 11 can be ultra-fast and can exhibit a sufficiently low error rate. For example, ultra-fast communication can have an error rate of less than about 0.1% to about 1%. A threshold for a low error rate for decoding a encoded signal transmission including a two-digit checksum value can be about 0.4% maximum error rate for a 0.13-0.33 second single-repeat decoding process. In some implementations, a sequence not including a checksum can lead to an increased error rate in noisy environments such that the receiver needs to perform multiple decodes to have high confidence the data sequence is correctly decoded. In other words, the sequence is transmitted multiple times in order to provide the receiver sufficient opportunities to decode the correct data sequence.

FIG. 12 depicts an example pulse sequence including predefined encoded values and including a single-digit checksum sequence. The single-digit checksum can be included in the pulse sequence for a relatively simple measure of error detection. In this case, the hexadecimal digits “9” and “D” are transmitted, followed by a “Checksum Start” identifier code. The checksum is calculated as the sum of the number of camera frames used to represent all the transmitted characters. For example, 10 camera frames for the “9,” plus 14 camera frames for the “D”=24 frames total (decimal)=18 (hexadecimal). Since only a single checksum digit is sent prior to the “Stop” code, the single digit is the least-significant digit of the 18 (hex), or “8.” The decoding application on the mobile device can then verify that the number of frames it captured and decoded for the digits add up to the same checksum value. In the case that the checksum values match, the decoding application can conclude that the transmission is verified, and it can terminate decoding the signal. In the case that the checksum values do not match, the decoding application can attempt again to capture and decode the transmitted signal.

In some implementations, additional checksums values can be added to the transmitted data sequence in order to further reduce the probability of error in the transmission of the pulse sequence not being detected or corrected. FIG. 13 depicts an example pulse sequence of predefined encoded values and including a two-digit checksum sequence. In the example depicted in FIG. 13, the hexadecimal digits “9” and “D” are transmitted, followed by a “Checksum Start” identifier code. The checksum is calculated as the sum of the number of camera frames used to represent all the transmitted characters. In this case, 10 camera frames for the “9”, plus 14 camera frames for the “D”=24 frames total (decimal)=18 (hexadecimal). Since two checksum digits are sent prior to the “Stop” code, they are the least-significant two digits of the 18 (hex), or “18”. The decoding application then verifies that the number of frames captured by the camera of the mobile device representing the digits add up to the same checksum value. In the case that the checksum values match, the decoding application can assume that the transmission is verified, and it can terminate decoding the signal. In the case that the checksum values do not match, the decoding application can attempt again to capture and decode the transmitted signal. In some implementations, the approach described with respect to FIG. 13 can be extended to N-number of checksum digits, with potentially diminishing returns.

FIG. 14 depicts an example pulse sequence of user-defined encoded values and including a single-digit checksum sequence. The data sequence depicted in FIG. 14 illustrates a transmission of two user-defined codes with a single checksum digit. User codes can be defined, for example, as non-Latin characters or symbols (e.g., Kanji strokes, Greek letters, punctuation, etc.), system fault/warning codes (e.g., “Low on Ink; Conveyor stopped; etc.), mapped system IP addresses (e.g., Printer “1” maps to 168.168.168.192; Printer “2” maps to 168.168.168.195, etc.), or another user-defined code that conforms to the structure of the optical encoding scheme. The checksum is calculated as the sum of the number of camera frames used to represent all the transmitted characters. In this case, 7 camera frames for the first user code, plus 16 camera frames for the second=23 frames total (decimal)=17 (hexadecimal). Since only a single checksum digit is sent prior to the “Stop” code, the single digit is the least-significant digit of the 17 (hex), or “7”.

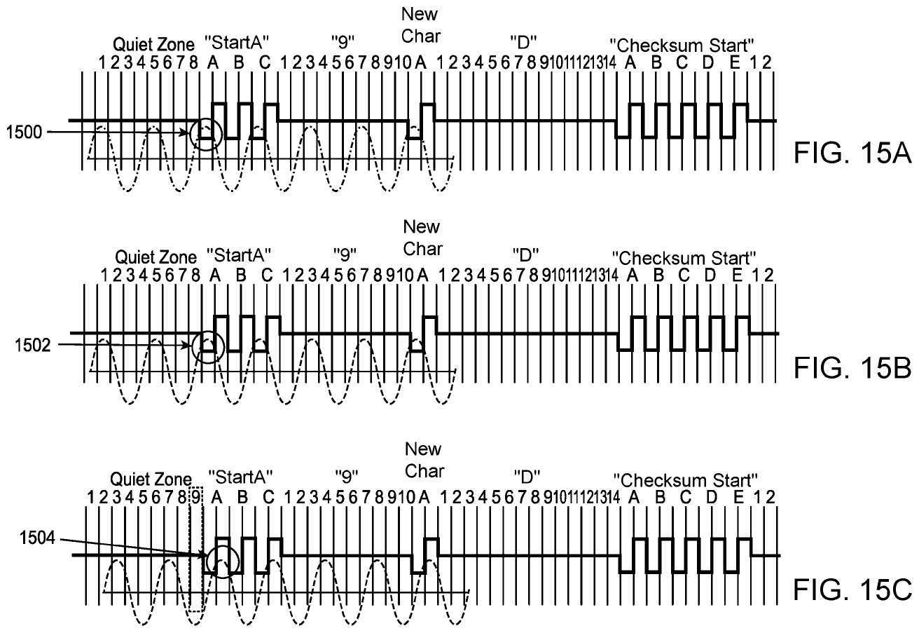

In some implementations, encoding data at video frame rates such as 240 fps has the potential for power line interference with the optical signal. In other words, one fundamental approach to noise reduction is to sample independent views of a message and average them together, resulting in a noise reduction=\sqrt{N}, where N is the number of independent samples. For example, as shown in the example depicted in FIG. 15A, if the first “0%” low-light pulse at the beginning of a “Start-A” command coincides with the 60 Hz sine wave bright peak 1500 of the ambient lighting the first time a message was transmitted, a probability that the same command coincides with the 60 Hz sine wave bright peak of the ambient lighting can lower during a second transmission. However, if the message length is a multiple of 4 frames (240 Hz/4=60 Hz), the second message transmission and every transmission thereafter will exhibit the same sub-optimal power-phase relationship where the sine wave bright peak 1502 overlaps with the low-light pulse at the beginning of a “Start-A” command, as shown in the example depicted in FIG. 15B. Consequently, the samples aren't independent and therefore no noise reduction is likely. This example scenario can be problematic for an optical encoding scheme, because the receiver is unable to communicate back to the transmitter regarding the problem, such that a different power-phase relationship can be used to transmit the information. However, if the message length is counted in frames, the problem can be avoided by adding a blank (Quiet Zone) frame if necessary to guarantee that the message is never a multiple of 60 Hz such that the sine wave bright peak 1504 does not overlap with the first low-light pulse of the “Start-A” command, e.g., as shown as added frame “9” of the Quiet Zone in the example depicted in FIG. 15C. In other words, a quiet zone frame(s) can be added such that the pulsed signal length is never a multiple of 240 fps/4=60 Hz, never a multiple of 480 fps/8=60 Hz, or never a multiple of 960 fps/16=60 Hz.

In some implementations, transmitting the encoded information can be performed by two or more light sources. For example, a deployed system in a production environment can include a light tower with multiple light sources each configured to emit a different wavelength range, e.g., two or more of red, green, yellow, blue, and white. In another example, a deployed system in a production environment can include multiple LEDs each configured to emit a different wavelength range, e.g., two or more of red, green, yellow, blue, and white. The different colors emitted by the respective light sources can be used to transmit color-coded information. For example, color-based signaling can include (A) Fault (steady red light)—send printer ID, fault code, (B) warning (flashing red or steady orange light)—send printer ID, warning code, (C) printer warming Up—(flashing green or steady yellow light)—send printer ID, “warming up” code, and (D) normal operation (steady green light)—send printer ID only. The decoding application can be operable to recognize a color that is flashing, know which type of information is being conveyed, and interpret it appropriately, using a minimal amount of data. For example, a printer ID can be just one or two hex digits, the same for a fault or warning code. With an added checksum digit, all the information can be conveyed with 3-5 digits-resulting in fast decoding of the transmitted message.

In some implementations, the light-based digital communication system can utilize a multi-color light source, such as a multi-color LED. The system can use the different colors of the multi-color light source to represent different types of data or to increase the amount of data that can be transmitted in a single light pulse. For example, red represents error codes, green indicates operational status, and blue conveys device identification data. Color-coding of data transmission can enhance the efficiency of data transmission and allow for quicker identification of specific types of data by the decoding application.

### Operation of Light Source(s) to Transmit Information

In some implementations, a light source coupled to a deployed system in a production environment can be a tower light. The tower light can be configured to signal additional information, e.g., system status, fault/error, connectivity, etc., in addition to transmitting the optically encoded data as described above. In some implementations, a controller including one or more processors in data communication with one or more memory storage can be configured to provide control signals to the light source(s) to transmit the encoded data. The controller can be a component of the system, e.g., a component of a computer system of the system, and/or can be an added component (e.g., an auxiliary controller) to the system to perform the operations described in this specification. In some implementations, the controller can include intensity modulators and/or AND Gates configured to adjust an output light signal for the light source(s), e.g., to adjust an output light intensity of the light source(s). Adjusting the output light signal can be performed dynamically, e.g., to pulse the light source(s) in accordance with the optical encoding scheme described in this specification.

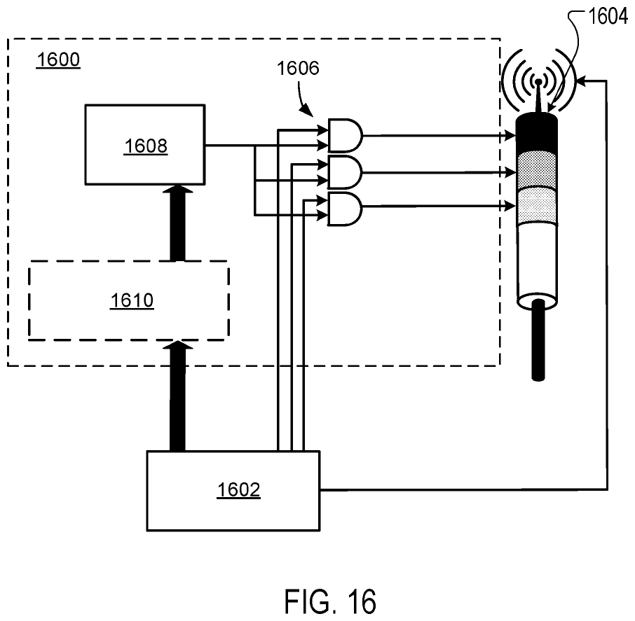

FIG. 16 depicts a schematic of an example controller 1600 for operating light source(s) 1604 of a printer 1602. Light source(s) 1604 can be, for example, a tower light including one or more light sources, e.g., red, yellow, and green LEDs. The controller can determine whether or not the printer 1602 is on or off, e.g., whether or not the light source(s) are illuminated or in a “not ready” condition (e.g., a solid red signal). In instances where the printer 1602 is turned on, at least one light of the tower light 1604 is illuminated, such that the light that is illuminated can be used to transmit information according to the encoding schemes described in this specification using control circuitry 1606. The controller 1608 can use the control circuitry 1606 to control the operation of the light source(s) 1604 of the printer 1602, e.g., each of the light source(s) 1604 can be operated separated using the control circuitry 1606. For example, the control circuitry 1606 includes AND gates in a Printer ID Pulse Encoder circuit whose output is AND-ed with the on/off signals for each color's LED, so that whichever light is on is always flashing with the printer ID of the printer 1602. In another example, the control circuitry 1606 includes intensity modulators, where the controller 1608 can modulate the light source output intensity between 100% and 50% brightness, for example. In some implementations, the controller 1608 is operable to transmit factory-specific LUT codes 1610, where each of N different printers in that facility has an associated set of unique low-flicker block codes (e.g., 168.1.1.70 is equal to “3”). In some implementations, the controller 1608 is operable to transmit the IP address, Bluetooth address, or other wireless address, e.g., as described in this specification.

In some implementations, the tower light depicted in FIG. 16 includes an RF antenna embedded within the blinking signal tower light to provide Wi-Fi, Bluetooth, or other wireless interface to the printer.

### Optical Decoding Scheme

A decoding application operating on a user's mobile device, e.g., a smart phone, can be in data communication with a camera of the mobile device and can access frames captured by the camera of the light source transmitting a pulse sequence, e.g., pulse sequences described with reference to FIGS. 5, 11-14, and including code identifiers, e.g., code identifiers described with reference to FIGS. 6-10. The decoding application can activate a fast-framing (e.g., 240 fps) video capture functionality of the camera and present, in an application environment (e.g., graphical user interface) within the display of the mobile device, the video in real-time to assist/guide a user to capture the light source within a reference window displayed in the application environment. For example, the application environment can include a reference window and guiding signals to assist the user in positioning the light source within the reference window for capturing the transmitting data.

In some implementations, the decoding application can use guiding signals to instruct the user to adjust a distance/orientation of the user's mobile device with respect to the light source. For example, the decoding application can use guiding signals to instruct the user to move closer/farther away to adjust a size of the light source within the reference window, e.g., +/−50%, to optimize a signal-to-noise ratio for the captured frames.

In some implementations, the decoding application performs pre-processing on the captured frames including the light source and the transmitted signal. For example, the decoding application can convert the captured frames including the light source into grayscale, e.g., to simplify/expedite the processing of the light signal being transmitted.

The decoding application can initiate a new receiving sequence for the transmitting signal and monitor for a code identifier indicative of a “start A” or “start B” code, e.g., as described above with reference to FIGS. 8 and 9 and the optical encoding scheme. In some implementations, the decoding application can decode a sequence of light pulses including a value of “N” frames (e.g., corresponding to an arbitrary alpha-numeric value). To decode the value “N,” the decoding application can create N image memory buffers (each large enough to store a single windowed image, but with 16-bit pixel depth, as opposed to 8-bit), where each buffer represents the summed images with delay i=Δt (NMIN<i<NMAX). After N×M frames, the maximum intensity value of each summed image is calculated, e.g., N=iMAX_INTENSITY, where Image_Buffer_i has the highest (summed) intensity.

In some implementations, immediately following the decoding application receiving and decoding a “start A” or “start B” code (e.g., as described above), the decoding application can proceed to count (e.g., increment a counter) of a number of 50% brightness frames following the “start A” or “start B” code and prior to receiving a “New character” code, e.g., as described with reference to FIG. 6, or a “checksum start” code identifier, e.g., as described with reference to FIG. 10. The decoding application can convert the total count into a predefined alpha-numeric value or text value, e.g., using LUT.

In some implementations, the decoding application will receive and decode a checksum start code identifier, which instructs the decoding application to count a number of 50% brightness frames succeeding a “start” code identifier and prior to a “new code” or “stop” code identifier. The decoding application can convert the number count to a predefined hexadecimal numeric value (e.g., 0-F) and validate the value against the checksum value transmitted by the light source. In an instance where the checksum values from the transmitter and receiver match, the decoding application can terminate the decoding sequence or proceed to a next decoding sequence. In an instance where the checksum values from the transmitter and receiver do not match, the decoding application can reinitiate a same decoding sequence, as described above. In some implementations, the decoding application can provide an alert to the user of the mobile device, e.g., in the application environment, to notify the user of the error.

In some implementations, various interference reduction techniques are implemented to improve the reliability and accuracy of the light-based digital communication system in challenging environments. For example, the system can use error correction codes to detect and correct errors that can occur during the transmission of light pulses. Error correction codes can be beneficial in environments with high levels of ambient light or electromagnetic noise, which can interfere with the light signal.

In some implementations, directional light sources and/or receivers are utilized, which help to focus the light signal and reduce the impact of ambient light. For example, the light source can be a laser diode, which emits light in a narrow beam, and the receiver can be equipped with a lens or other optical component that focuses the incoming light onto the camera sensor. Further details of direction light sources are discussed below.

In some implementations, the system uses modulation techniques to encode the data into the light signal in a way that is more resistant to interference. For example, the system can use frequency modulation, where the data is encoded into the frequency of the light pulses, rather than their intensity.

Interference reduction techniques can be used individually or in combination to enhance the performance of the light-based digital communication system in various environments.

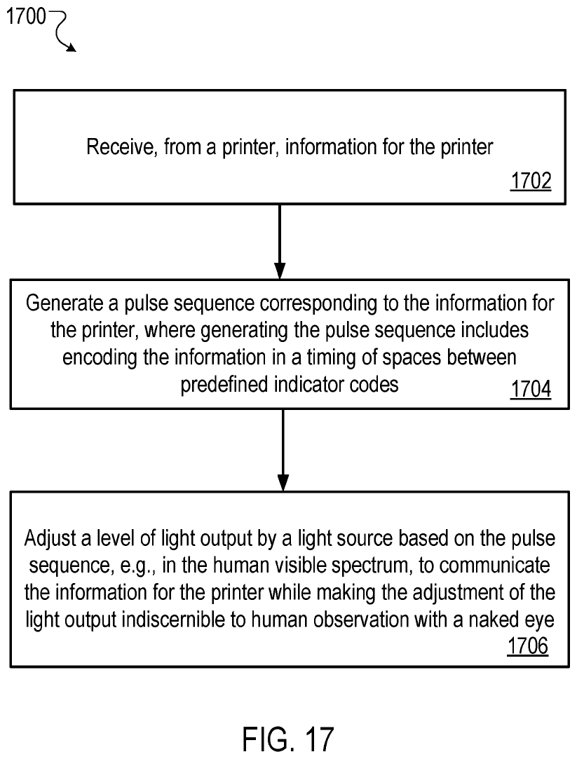

FIG. 17 is a flowchart of an example process 1700 for encoding digital communication and transmitting the encoded optical signal with a light source. For convenience, the process will be described as being performed by a system of one or more computers, located in one or more locations, and programmed appropriately in accordance with this specification, for example, by a controller of the printer or a controller that is retrofitted to the printer. The controller receives information for the printer (1702). The information can include, for example, a wired or wireless address of the printer. The controller generates a pulse sequence corresponding to the information for the printer, where generating the pulse sequence includes encoding the information in a timing of spaces between predefined indicator codes (1704). The controller can use a LUT including the pre-defined indicator codes and a set of pre-defined encoded alpha-numeric characters and/or user-defined codes corresponding to frames between the predefined indicator codes. The controller adjusts a level of light output by a light source based on the pulse sequences, e.g., in the human visible spectrum, to communicate the information for the printer while making the adjustment of the light output indiscernible to human observation with a naked eye (1706). The adjustment can be an adjustment in an intensity of the light output between 0-100% of the available range of light output for the light source, where a steady-state output can be 50% intensity of the available range of light output for the light source.

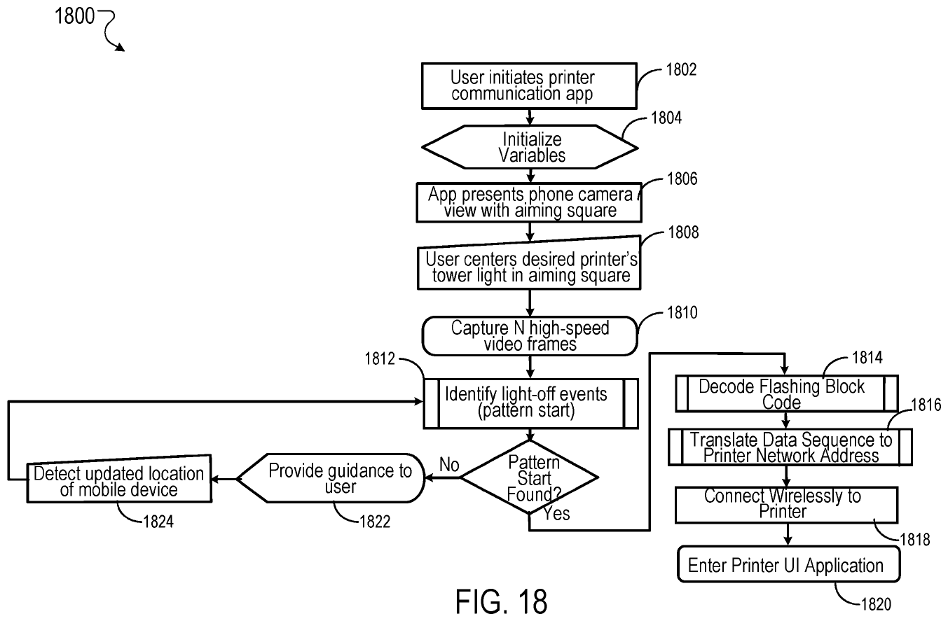

FIG. 18 is a flowchart of an example process 1800 for decoding digital communication from a light source. For convenience, the process will be described as being performed by a system of one or more computers, located in one or more locations, and programmed appropriately in accordance with this specification. A user initiates 1802 a decoding application on the user's mobile device, e.g., an “printer communication app”. The decoding application initializes 1804 variables and engages with the camera of the mobile device. The decoding application presents 1806 a view of the camera of the mobile device in a display window of the application environment and including a reference window, e.g., an “aiming square” indicating to the user where to align the light source of interest. The user can then center 1808 the light source within the reference window, e.g., center a printer's tower light within the aiming square. The decoding application proceeds to capture 1810 N high-speed video frames including the light source. The decoding application can identify 1812, within the captured video frames, a light-off event (e.g., a “start” code). In the case where a start or initialization code is identified, the decoding application can proceed to decode 1814 the data sequence (e.g., flashing block code) transmitted from the light source. The decoding data sequence can be translated 1816, e.g., using a LUT, into a pulse sequence including a unique identifier for the printer. The unique identifier for the printer, e.g., an IP address, can be processed by the decoding application to connect 1818 wirelessly to the printer by establishing a connection between the printer and the mobile device over a network. Once the connection is made between the printer and the mobile device, the user can enter 1820 the printer UI application. In a case where a pattern start is not found, the decoding application can provide 1822 guidance to the user, e.g., using guiding signals or text/audio-based alerts, to adjust in response. For example, the decoding application can prompt the user “signal too low, move closer to light.” In response to detecting 1824 an updated location of the mobile device with respect to the light source decoding application can retry to identify light-off events (or a pattern start event).

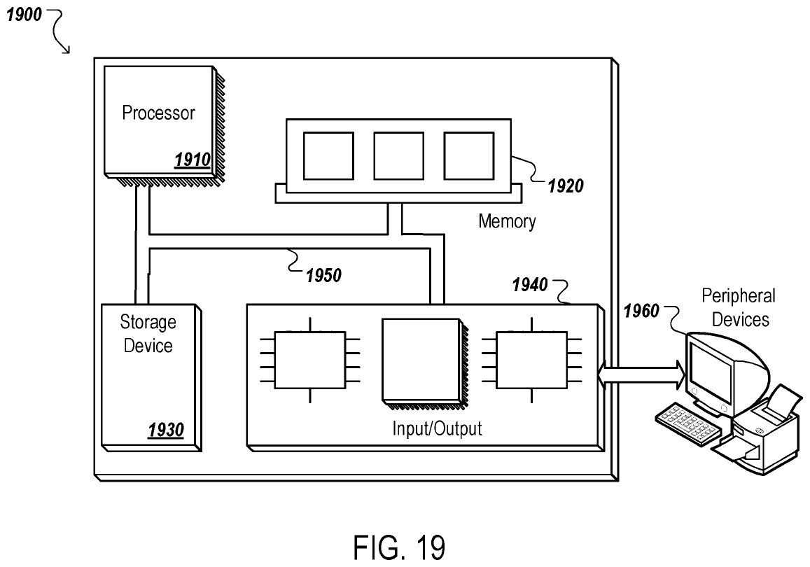

FIG. 19 is a block diagram of an example computer system 1900 that can be used to perform operations described above. For example, such as operations performed by the controller to encode information into a pulse sequence and/or operations performed by a mobile device running a decoding application. The system 1900 includes a processor 1910, a memory 1920, a storage device 1930, and an input/output device 1940. Each of the components 1910, 1920, 1930, and 1940 can be interconnected, for example, using a system bus 1950. The processor 1910 is capable of processing instructions for execution within the system 1900. In some implementations, the processor 1910 is a single-threaded processor. In some implementations, the processor 1910 is a multi-threaded processor. The processor 1910 is capable of processing instructions stored in the memory 1920 or on the storage device 1930.

The memory 1920 stores information within the system 1900. In some implementations, the memory 1920 is a computer-readable medium. In some implementations, the memory 1920 is a volatile memory unit. In some implementations, the memory 1920 is a non-volatile memory unit.

The storage device 1930 is capable of providing mass storage for the system 1900. In some implementations, the storage device 1930 is a computer-readable medium. In various implementations, the storage device 1930 can include, for example, a hard disk device, an optical disk device, a storage device that is shared over a network by multiple computing devices (e.g., a cloud storage device), or some other large capacity storage device.

The input/output device 1940 provides input/output operations for the system 1900. In some implementations, the input/output device 1940 can include one or more of a network interface device, e.g., an Ethernet card, a serial communication device, e.g., and RS-232 port, and/or a wireless interface device, e.g., and 802.11 card. In some implementations, the input/output device can include driver devices configured to receive input data and send output data to peripheral devices 1960, e.g., keyboard, printer and display devices. Other implementations, however, can also be used, such as mobile computing devices, mobile communication devices, set-top box television client devices, etc.

Although an example processing system has been described in FIG. 19, implementations of the subject matter and the functional operations described in this specification can be implemented in other types of digital electronic circuitry, or in computer software, firmware, or hardware, including the structures disclosed in this specification and their structural equivalents, or in combinations of one or more of them. For example, In some implementations a single integrated circuit chip can be integrated (e.g., retrofitted) into a deployed system/device including a light source.

### Infrared and Directed Signaling

In some implementations, a light source used for address identification and digital communications can be selected such that the wavelength of light of the light source is outside visible wavelength range of a human eye, e.g., outside the range of ~400-700 nm range. IR wavelengths, in particular near-IR wavelengths can be within a detectable range of wavelengths by cameras of mobile devices, e.g., smart phones and tablets. By selecting IR wavelengths for the address identification and digital communications, the light pulses are invisible to the human eye.

Many cameras of mobile devices include a spectral response extending into the infrared, e.g., extending to wavelengths of about 1000 nm. Though a sensitivity of the camera can be reduced in the infrared, e.g., due to image sensor detectability limits, by the inclusion of a filter with the camera, or both, a sufficiently bright infrared source can be used to provide light-based communication detectable in infrared by the receiving camera of the mobile device.

In some implementations, an infrared source emitting at 940 nm is used for the light-based communications. The 940 nm wavelength is absorbed by the Earth's atmosphere such that sunlight has a reduced presence of 940 nm light which can reduce interference from sunlight in light-based communication using an infrared light source. As result, infrared light-based communication can benefit from a robust, low-noise-susceptibility communications and result in improved signal-to-noise ratio for the light-based communication both in indoor and outdoor settings. Moreover, 940 nm light is detectable by common silicon-based detectors, which can reduce the barrier of implementing an infrared solution.

Infrared-based light signaling can be implemented using a similar protocol as described above with reference to visible light signaling. In some implementations, a relative luminescence required for threshold detectability of the infrared light source is higher than a luminescence required from threshold detectability of a visible light source, e.g., due to reduced sensitivity of mobile device cameras to infrared wavelengths. With sufficient intensity IR light sources, a transmission range up to about 150 meters is achievable.

In some implementations, a transmission range for a light-based digital communication system using an IR light source depends in part on a field of view of the receiving camera used to capture the light signal from the IR light source. A transmission range can depend in part on various factors, for example, the quality of the camera's sensor, characteristics of the IR light source, e.g., wavelength and beam divergence, and environmental conditions such as ambient light and physical obstructions. The light-based digital communication system can be optimized to a transmission range by adjusting operating parameters of the IR light source, e.g., intensity, beam angle in view of camera configuration, e.g., focal length, pixel size.

In some implementations, IR light signal can be used for digital communication over extended distances, e.g., up to about 150 meters, by configuring the IR light source intensity in view of the camera's detection capabilities. In one example, an IR light source delivering approximately 100 picoWatts (pW) per pixel at the camera, e.g., the camera of the mobile device, can enable communication up to about 150 meters in a lighted, indoor environment, depending on camera configuration and environmental quality. An intensity of the IR light source can be selected based in part on a threshold signal to noise ratio with ambient light, e.g., sunlight, in the production environment. In some implementations, characteristics of the IR light source can be selected such that the beam size at the location of the camera is less than a threshold area, e.g., a fraction of the field of view of the camera.

Equation 3 is a formulation for determining a field of view (FOV) of a camera:

$$FOV = 2 * {tan}^{- 1} ( \frac{\sqrt{{( Xpx * Dpx )}^{2} + {( Ypx * Dpx )}^{2}}}{2 * F L} ) \qquad ( 3 )$$

where Xₚₓ is a number of pixels in a cell phone camera in the X-direction, Yₚₓ is a number of pixels in a camera in the Y-direction, FL is the focal length of the camera, and DPₓ is the pixel pitch of the camera. For example, a mobile device can include a camera having the following specifications: 4032 pixels in the X-dimension Xₚₓ, 3024 pixels in the Y-dimension Yₚₓ, a pixel pitch DPₓ of 1.4 microns (μm), and a focal length FL of 26 millimeters.

The camera FOV can, in part, dictate an amount of IR light signal that is captured by the camera. Equation 4 is a formulation for determining a distance over which the IR light-based communication can be implemented, e.g., such that a threshold light intensity is capturable by the camera at the distance.

$$Drange = \frac{Hlamp}{2 * tan ( \frac{M * FOV}{2 * Xpx} )} \qquad ( 4 )$$

where D_{range} is a maximum distance between the camera and the IR light source, M is the minimum number of pixels in the camera's x-dimension required to detect the pulsing light, and Hₗₐₘₚ represents the effective height, e.g., size, of the IR light source. For example, an IR light source can have a height of 80 mm and the camera detecting the IR light source can require a minimum of 8 pixels to be able to detect the light signal from the IR light source.

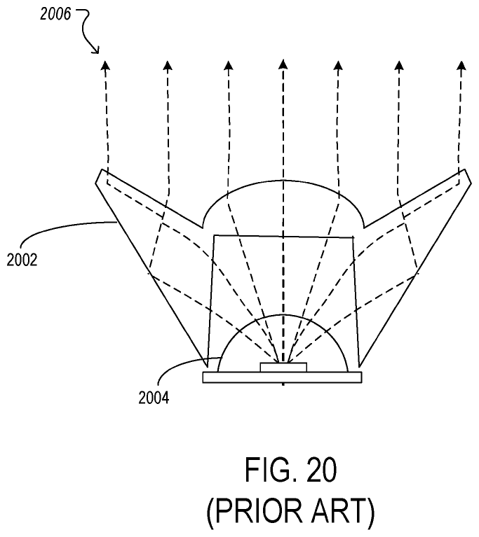

In some implementations, a directed signaling source is used for address identification and digital communications. A directed signaling source can induce a narrow-beam source such as lasers or LEDs coupled to focusing optics to narrow the emission to a narrow, non-omnidirectional, cone or focused beam of light. For example, a directed signaling source can be a conical transmitter, e.g., a flashlight or a laser with defocusing optics. FIG. 20 depicts an example of using focusing optics 2002 with an LED 2004 to produce a narrow, non-omnidirectional beam of light 2006 from the emission of the LED 2004.

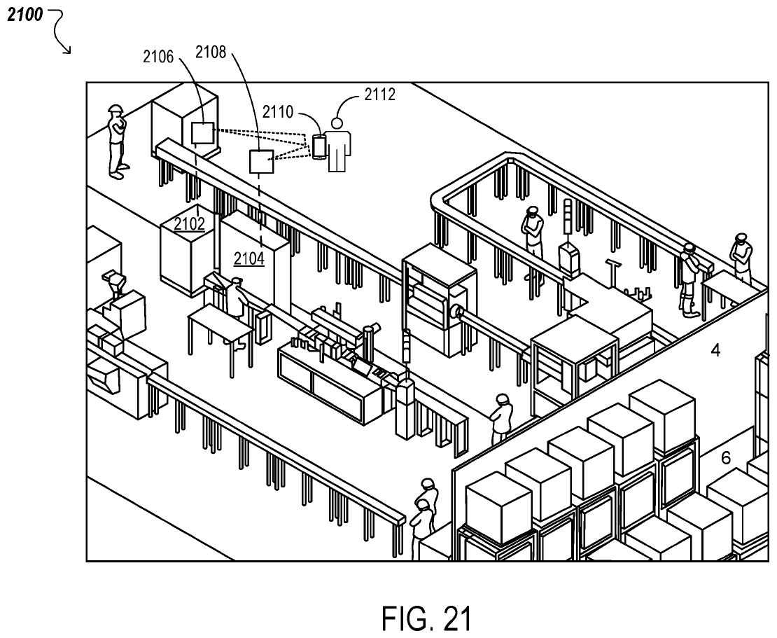

A narrow, directional, pulsed light source can provide increased range of detectability of the light signal by a camera of a mobile device. Additionally, by using a more focused beam of light, two or more light sources can be arranged, e.g., in an array, to provide the ability to query numerous production systems from a central location. Each of the two or more light sources, e.g., tens of light sources, hundreds of light sources, or more, are positioned such that the emitted light signals of each light source is directed towards a same location in the production environment such that a user with a mobile device can capture the light signals from the two or more light sources from one location. For example, as depicted in FIG. 21, a production environment 2100 includes two or more production systems, e.g., systems 2102, 2104, with respective light sources, e.g., light sources 2106, 2108, each positioned to emit light signal directed to a single location and capturable by a camera of a mobile device 2110 positioned at the single location, e.g., with reduced interference between the light sources due to the focused beam. A person 2112 (or two, three, five people) with the mobile device(s) 2110 can stand in a single location, e.g., an area accommodating the people, and communicate with two or more production systems by directing the camera of the respective mobile device(s) to capture the light signal emitted by a respective infrared light source projector that includes the production system ID number.

In some implementations, a directed signaling source is used for secure, line-of-sight communications, e.g., device-to-device. In addition to being invisible to the human eye due to wavelength selection and pulse speed of the light signal, using line-of-sight can increase security awareness of interception and tampering since intercepting the signal can block the intended recipient, thereby alerting the recipient to a potential breach.

In some implementations, the light-based digital communication system incorporates quantum cryptography principles to enhance the security of data transmission. Quantum key distribution protocols can be used to securely share encryption keys between devices, ensuring that the data encoded into light emissions is securely encrypted and resistant to interception.

In some implementations, an industrial device can use the light-based data communication and identification processes described in this specification to identify itself, provide status updates (e.g., the device's latest status), and provide an IP address (e.g., a modified IP address), error code(s), etc., to a user with a mobile device. For an environment including multiple industrial devices, each industrial device can be identified by encoding a unique universal product code (UPC) code, for example, in a pulse stream and including the “Start A” or “Start B” described above to identify status codes, IP or Bluetooth addresses, or a combination of both. Industrial devices can include, for example, devices used in the automotive, battery manufacturing, warehouse, shipping/logistics, postal, HVAC (heating, ventilation, and air conditioning) systems, and oil processing facilities. Moreover, in any of these instances, the infrared-based light signaling, the processes provide secure device-to-device communications, device-to-person communications, or a combination of both.

While the technology here is generally described with reference to production environments, for example, including printers and manufacturing equipment, it can also be applied to any scenario where remote monitoring of a device is beneficial. For example, it can be used to monitor the status of HVAC systems, automobile maintenance intervals, or any other device that can emit light.

In some implementations, the light source can be integrated with other types of sensors, such as temperature, humidity, vibration, and sound sensors, to provide more comprehensive monitoring and control of the device. The sensor data can be encoded into light pulses along with the device status information, allowing for more detailed and accurate device diagnostics.

In some implementations, the light-based digital communication system is integrated with other types of devices such as autonomous vehicles, drones, robots, and IoT devices. For example, the light-based digital communication system can be used to facilitate communication between autonomous vehicles. In some examples, the light-based digital communication system can be used to enable drones to transmit data to ground control stations using light signals. The light-based digital communication technology can be extended to non-industrial environments. For instance, the technology can be applied in smart homes, healthcare facilities, educational institutions, data centers, and transportation systems, among others.

In some implementations, the light-based digital communication system is integrated with a smart home. For example, the system can be used for monitoring and controlling various home appliances, such as refrigerators, washing machines, heating systems, and home security devices. In some examples, a smart refrigerator can encode its status information, such as temperature, power consumption, and food inventory, into light pulses. The light pulses can then be captured by a user's mobile device, decoded, and presented to the user, allowing the user to monitor and control the refrigerator remotely. Smart home monitoring can result in improved convenience for the user as well as improved efficiency of home management.

In some implementations, the light-based digital communication system is integrated with healthcare facilities. For example, the system can be used to monitor and control medical devices. In some examples, a medical device, such as an infusion pump or a patient monitor, can encode its status information, such as operational parameters, alarm conditions, and patient data, into light pulses. The light pulses can then be captured by a healthcare provider's mobile device, decoded, and presented to the healthcare provider. Integrated light-based digital communication allows healthcare providers to monitor and control medical devices remotely, improving patient care and operational efficiency.

In some implementations, the light-based digital communication system is integrated with educational institutions. For example, the system can be used to enhance classroom management and student engagement. In some examples, a smart classroom system can encode information, such as classroom schedule, student attendance, and interactive content, into light pulses. The light pulses can then be captured by a teacher's or student's mobile device, decoded, and presented to the user, enhancing the educational experience.

In some implementations, the light-based digital communication system is integrated with data centers. For example, the system can be used for real-time monitoring and control of servers and networking equipment. In some examples, a server can encode its status information, such as CPU usage, memory usage, and network traffic, into light pulses. The light pulses can then be captured by a data center operator's mobile device, decoded, and presented to the operator, enabling efficient data center management.

In some implementations, the light-based digital communication system is integrated with transportation systems. For example, the system can be used for vehicle-to-vehicle and vehicle-to-infrastructure communication. In some examples, a vehicle can encode its status information, such as speed, direction, and braking status, into light pulses. The light pulses can then be captured by another vehicle's or infrastructure's sensor, decoded, and used for collision avoidance, traffic management, and other applications.

In some implementations, the light-based digital communication system includes additional or alternative types of light sources and detectors. For example, in addition to visible light, the technology can use ultraviolet or infrared light for data transmission. Using non-visible light sources can enhance the security and reliability of the communication, as these types of light are less susceptible to interference and eavesdropping.

In some implementations, the light-based digital communication system uses other types of light detectors, such as photodiodes, for capturing light pulses in addition to or alternatively to using cameras of user devices. This can improve the speed and accuracy of the data capture, by using detectors that have higher sensitivity and faster response times than mobile-integrated cameras.

In some implementations, the light-based digital communication system can be combined with other communication technologies, such as radio frequency (RF) and acoustic communication, for enhanced functionality and flexibility. For example, a device can use light-based communication for transmitting status information and RF or acoustic communication for transmitting control commands. This can provide a more robust and versatile communication solution, as each communication technology has its own strengths and weaknesses.

In some implementations, the device continuously emits light encoded with its status information. This allows for real-time monitoring of the device status. In some implementations, the device emits light encoded with its status information in response to a specific trigger. For example, a fault condition, a request for status information, or any other event that requires communication of the device status. In either implementation, the light emissions can be captured by a camera and decoded to retrieve the status information. The camera can focus on a specific device to read its light emissions, allowing for individual device monitoring in an environment with multiple devices.

In some implementations, the light emissions of the light-based digital communication system are used to communicate an ID that allows for wireless connection to the device for more detailed status information or control.

The subject matter and the actions and operations described in this specification can be implemented in digital electronic circuitry, in tangibly-embodied computer software or firmware, in computer hardware, including the structures disclosed in this specification and their structural equivalents, or in combinations of one or more of them. The subject matter and the actions and operations described in this specification can be implemented as or in one or more computer programs, e.g., one or more modules of computer program instructions, encoded on a computer program carrier, for execution by, or to control the operation of, data processing apparatus. The carrier can be a tangible non-transitory computer storage medium. Alternatively, or in addition, the carrier can be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random-access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. The mass storage devices can be, for example, magnetic, magneto-optical, or optical disks, or solid-state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, the subject matter described in this specification can be implemented on one or more computers having, or configured to communicate with, a display device, e.g., a LCD (liquid crystal display) monitor, or a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech or tactile; and input from the user can be received in any form, including acoustic, speech, or tactile input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

Although the present application is defined in the attached claims, it should be understood that the present invention can also (additionally or alternatively) be defined in accordance with the following examples:

Example 1 is a system including a printer, a light source associated with the printer and configured to emit light at one or more wavelengths, and a controller coupled with the light source. The controller is configured to generate a pulse sequence corresponding to information for the printer, and adjust a level of light output by the light source based on the pulse sequence to communicate the information for the printer while making the adjustment of the light output indiscernible to human observation with a naked eye.

Example 2 is the system of example 1, where the one or more wavelengths includes a wavelength of infrared light.

Example 3 is the system of example 2, where the wavelength of infrared light includes 940 nanometer light.

Example 4 is the system of any of the examples 1 to 3, where the one or more wavelengths comprise a wavelength of visible light and a wavelength of infrared light.

Example 5 is the system of any of the examples 1 to 4, where the controller is configured to adjust the level of the light output by the light source in accordance with predefined indicator codes, wherein a timing of spaces between the indicator codes, during which the level of the light output is not adjusted, indicates the information being communicated.

Example 6 is the system of any of the examples 1 to 5, where the information comprises a wired or wireless network address for the printer.

Example 7 is the system of any of the examples 1 to 6, where the controller is communicatively coupled with the printer, and the controller is configured to: receive, from the printer, data for the printer; and encode the data for the printer in the timing of the spaces between the predefined indicator codes to generate the pulse sequence.

Example 8 is the system of any of the examples 1 to 7, where the controller is configured to make the adjustment of the light output in a human visible spectrum indiscernible to human observation with a naked eye at least in part by adjusting the level of the light output at a frequency above 75 Hertz.

Example 9 is the system of any of the examples 1 to 8, where the light source includes (i) a tower light, (ii) a light emitting diode or (iii) a laser source.

Example 10 is the system of example 9, where the light source comprises the light emitting diode coupled with focusing optics to produce a narrow beam illumination source.

Example 11 is the system of any of the examples 1 to 10, where the light source is a first light source, and wherein the system further includes a second light source comprising a different emission wavelength from the first light source, where the controller is coupled with the second light source. The controlled is configured to generate a second pulse sequence corresponding to second information for the printer, and adjust a level of light output by the second light source based on the second pulse sequence to communicate the second information for the printer while making the adjustment of the light output indiscernible to human observation with the naked eye.

Example 12 is the system of any of the examples 1 to 11, where the information further includes one or more of (A) a printer status update, (B) a fault/error code, (C) connectivity information, or (D) printer or software configuration information.

Example 13 is the system of any of the examples 1 to 12, where adjusting the level of light output by the light source comprises adjusting an intensity of the light output of the light source between 0 to 100%.

Example 14 is the system of example 13, where the pulse sequence causes adjustment of the light output of the light source to a steady-state of 50% intensity of a total light output for the light source for a period of time.

Example 15 is the system of examples 13 or 14, where a period of a light pulse of the pulse sequence is selected based on a frame rate of a receiving camera of a mobile device.

Example 16 is the system of any of examples 13 to 15, where generating the pulse sequence includes encoding the information using an encoding scheme including valid states of 0%, 50% and 100% intensity of the light source, wherein a steady-state of the light source comprises a 50% intensity of the light source.

Example 17 is the system of example 16, where the encoding scheme includes (i) a defined state and end of pulse sequences and (ii) a defined character map(s).

Example 18 is the system of any of examples 1 to 17, where the controller is configured to generate the pulse sequence by performing operations including determining a number of frames for the pulse sequence corresponding to the information, and in response to determining the number of frames is a multiple of 50 Hz or 60 Hz, inserting an additional frame into the pulse sequence to reduce a sensitivity to the 50 Hz or 60 Hz ambient light flashing.

Example 19 is the system of any of examples 16 to 18, where the encoding scheme includes alpha-numerical characters as the steady-state of the light source, where a value of the alpha-numerical characters is encoded as steady-state light signal for a set number of frames of a receiving camera of a mobile device.

Example 20 is the system of any of examples 16 to 19, where the encoding scheme includes a set of indicator codes, each of the indicator codes including a predetermined number of sequential light pulses, where the set of indicator codes includes: (A) a start code corresponding to a predefined code, (B) a start code corresponding to a user-defined code, (C) a new character code, and (D) a stop code.

Example 21 is the system of example 20, where the set of indicator codes further includes a validation code, and where the validation code includes a checksum start code.

Example 22 is one or more non-transitory computer storage media encoded with computer program instructions that when executed by one or more computers cause the one or more computers to perform operations including: initiating a decoding application in an application environment on a user device, the decoding application accessing a camera of the user device, presenting, in a display of the user device and in the application environment, a view of the camera of the user device, where the view of the camera includes a reference window guiding a user to capture a light signal from a light source of interest, capturing, using the camera, a plurality of video frames including the light signal from the light source, and identifying, by the decoding application and within the captured plurality of video frames, a pulse sequence in the light signal emitted by the light source, the pulse sequence encoding information.

Example 23 is a computer-implemented method including generating, by a controller coupled to a light source associated with a printer, a pulse sequence corresponding to information for the printer, where the light source is configured to emit light in a human visible spectrum, and adjusting, by the controller, a level of light output by the light source based on the pulse sequence, in the human visible spectrum, to communicate the information for the printer while making the adjustment of the light output indiscernible to human observation with a naked eye.

Example 24 is the computer-implemented method of example 23, further including initiating a decoding application in an application environment on a user device, the decoding application accessing a camera of the user device, presenting, in a display of the user device and in the application environment, a view of the camera of the user device, where the view of the camera includes a reference window guiding a user to capture a light signal from the light source, the light signal including the pulse sequence corresponding to the information for the printer, capturing, using the camera, a plurality of video frames including the light signal from the light source, and identifying, by the decoding application and within the captured plurality of video frames, the pulse sequence in the light signal emitted by the light source, the pulse sequence encoding the information for the printer.

Example 25 is a system comprising: one or more computers and one or more storage devices storing instructions that are operable, when executed by the one or more computers, to cause the one or more computers to perform the method of any one of examples 23 to 24.

Example 26 is a computer program carrier encoded with a computer program, the program comprising instructions that are operable, when executed by one or more computers, to cause the one or more computers to perform the method of any one of examples 23 to 24.

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this by itself should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A system comprising:
a printer;
a light source associated with the printer and configured to emit light at one or more wavelengths; and
a controller coupled with the light source and configured to
generate a pulse sequence corresponding to information for the printer, and
adjust a level of light output by the light source based on the pulse sequence to communicate the information for the printer while making the adjustment of the light output indiscernible to human observation with a naked eye.

2. The system of claim 1, wherein the one or more wavelengths comprise a wavelength of infrared light, a wavelength of visible light, or a wavelength of visible light and a wavelength of infrared light.

3. The system of claim 2, wherein the wavelength of infrared light comprises 940 nanometer light.

4. (canceled)

5. The system of claim 1, wherein the controller is configured to adjust the level of the light output by the light source in accordance with predefined indicator codes, wherein a timing of spaces between the indicator codes, during which the level of the light output is not adjusted, indicates the information being communicated.

6. The system of claim 5, wherein the information comprises a wired or wireless network address for the printer.

7. The system of claim 5, wherein the controller is communicatively coupled with the printer, and the controller is configured to:
receive, from the printer, data for the printer; and
encode the data for the printer in the timing of the spaces between the predefined indicator codes to generate the pulse sequence.

8. The system of claim 7, wherein the controller is configured to make the adjustment of the light output in a human visible spectrum indiscernible to human observation with a naked eye at least in part by adjusting the level of the light output at a frequency above 75 Hertz.

9. The system of claim 1, wherein the light source comprises (i) a tower light, (ii) a light emitting diode or (iii) a laser source, and wherein a period of a light pulse of the pulse sequence is selected based on a frame rate of a receiving camera of a mobile device.

10. The system of claim 9, wherein the light source comprises the light emitting diode coupled with focusing optics to produce a narrow beam illumination source.

11. The system of claim 1, wherein the light source is a first light source, and wherein the system further comprises a second light source comprising a different emission wavelength from the first light source, wherein the controller is coupled with the second light source and configured to
generate a second pulse sequence corresponding to second information for the printer, and
adjust a level of light output by the second light source based on the second pulse sequence to communicate the second information for the printer while making the adjustment of the light output indiscernible to human observation with the naked eye.

12. The system of claim 1, wherein the information further includes one or more of (A) a printer status update, (B) a fault/error code, (C) connectivity information, or (D) printer or software configuration information.

13. The system of claim 1, wherein adjusting the level of light output by the light source comprises adjusting an intensity of the light output of the light source between 0 to 100%, and
wherein the pulse sequence causes adjustment of the light output of the light source to a steady-state of 50% intensity of a total light output for the light source for a period of time.

14. (canceled)

15. (canceled)

16. The system of claim 1, wherein generating the pulse sequence comprises encoding the information using an encoding scheme comprising valid states of 0%, 50% and 100% intensity of the light source, wherein a steady-state of the light source comprises a 50% intensity of the light source.

17. The system of claim 16, wherein the encoding scheme includes (i) a defined state and end of pulse sequences and (ii) a defined character map(s).

18. The system of claim 16, wherein the controller is configured to generate the pulse sequence by performing operations comprising:
determining a number of frames for the pulse sequence corresponding to the information; and
in response to determining the number of frames is a multiple of 50 Hz or 60 Hz, inserting an additional frame into the pulse sequence to reduce a sensitivity to the 50 Hz or 60 Hz ambient light flashing.

19. The system of claim 16, wherein the encoding scheme includes alpha-numerical characters as the steady-state of the light source, wherein a value of the alpha-numerical characters is encoded as steady-state light signal for a set number of frames of a receiving camera of a mobile device.

20. The system of claim 16, wherein the encoding scheme comprises a set of indicator codes, each of the indicator codes comprising a predetermined number of sequential light pulses, wherein the set of indicator codes includes: (A) a start code corresponding to a predefined code, (B) a start code corresponding to a user-defined code, (C) a new character code, and (D) a stop code, and
wherein the set of indicator codes further comprises a validation code, wherein the validation code comprises a checksum start code.

21. (canceled)

22. One or more non-transitory computer storage media encoded with computer program instructions that when executed by one or more computers cause the one or more computers to perform operations comprising:
initiating a decoding application in an application environment on a user device, the decoding application accessing a camera of the user device;
presenting, in a display of the user device and in the application environment, a view of the camera of the user device, wherein the view of the camera includes a reference window guiding a user to capture a light signal from a light source of interest;
capturing, using the camera, a plurality of video frames including the light signal from the light source; and
identifying, by the decoding application and within the captured plurality of video frames, a pulse sequence in the light signal emitted by the light source, the pulse sequence encoding information.

23. A method comprising:
generating, by a controller coupled to a light source associated with a printer, a pulse sequence corresponding to information for the printer, wherein the light source is configured to emit light in a human visible spectrum; and
adjusting, by the controller, a level of light output by the light source based on the pulse sequence, in the human visible spectrum, to communicate the information for the printer while making the adjustment of the light output indiscernible to human observation with a naked eye.

24. The method of claim 23, further comprising:
initiating a decoding application in an application environment on a user device, the decoding application accessing a camera of the user device;
presenting, in a display of the user device and in the application environment, a view of the camera of the user device, wherein the view of the camera includes a reference window guiding a user to capture a light signal from the light source, the light signal including the pulse sequence corresponding to the information for the printer;
capturing, using the camera, a plurality of video frames including the light signal from the light source; and
identifying, by the decoding application and within the captured plurality of video frames, the pulse sequence in the light signal emitted by the light source, the pulse sequence encoding the information for the printer.
